(19) United States
(12) Patent Application Publication
(10) Pub. No.: US 2010/0163503 A1
(43) Pub. Date: Jul. 1, 2010

(54) COMPUTERIZED LOCKING SYSTEM FOR STORAGE OF BICYCLES AND ACCESSORIES

(76) Inventor: MICHAEL JAMES KELLY, Baltimore, MD (US)

Correspondence Address: Michael Kelly, 1211 Light Street, Baltimore, MD, 21230, US

(21) Appl. No.: 12/649,593

(22) Filed: Dec. 30, 2009

Related U.S. Application Data
(60) Provisional application No. 61/141,349, filed on Dec. 30, 2008.

(51) Int. Cl. A47F 7/19; A47F 7/00; B62H 5/00; G06K 5/00

(52) U.S. Cl. 211/85.3; 211/85.7; 70/233; 235/382

(57) ABSTRACT

A computerized locking system for storage of bicycles and accessories includes: plurality of receiving bays to releasably secure the bicycles; a plurality of equipment storage units; a support surface for the receiving bays and the equipment storage units; and a computerized access box. The access box controls the locking and releasing of the bicycle and the storage unit.

### RELATED APPLICATIONS

The present application claims benefit of priority from U.S. Provisional Application No. 61/141,349, filed Dec. 30, 2008, which is incorporated herein by reference in its entirety.

### BACKGROUND OF THE INVENTION

The present invention generally relates to locks, and more specifically, to a computerized locking system for storage of bicycles and accessories.

### SUMMARY OF THE INVENTION

In one aspect of the present invention, a device for a bicycle and equipment includes: a receiving bay to releasably secure the bicycle; a storage unit to store the equipment; and a computerized access box; wherein the access box controls the locking and releasing of the receiving bay and the storage unit.

In another aspect of the present invention, a device for a plurality of bicycles includes: a plurality of receiving bays to releasably secure the bicycles; a plurality of equipment storage units; a support surface for the receiving bays and the equipment storage units; and a computerized access box; wherein the access box controls the locking and releasing of the bicycle and the storage unit.

These and other features, aspects and advantages of the present invention will become better understood with reference to the following drawings, description and claims.

### BRIEF DESCRIPTION OF THE DRAWINGS

FIG. 1 depicts a perspective view of an embodiment of the present invention;

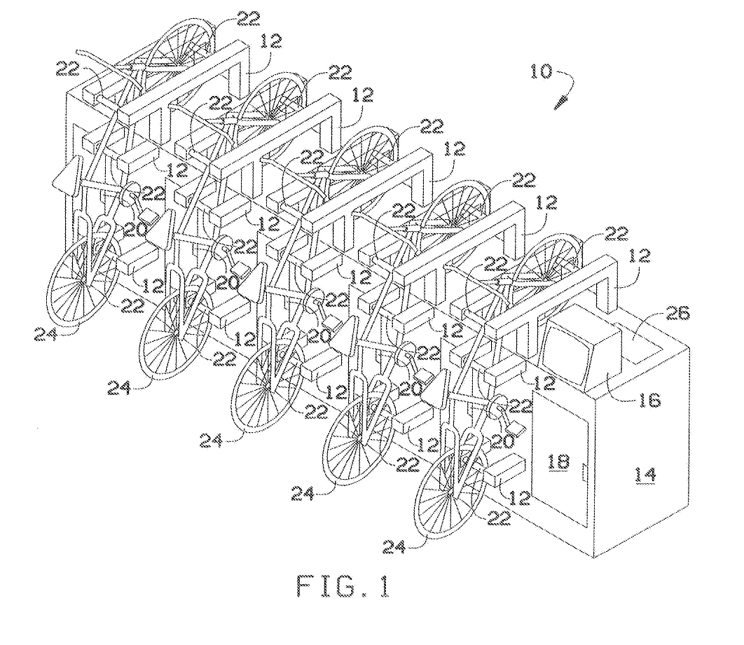

FIG. 2 depicts a top view of the embodiment of FIG. 1;

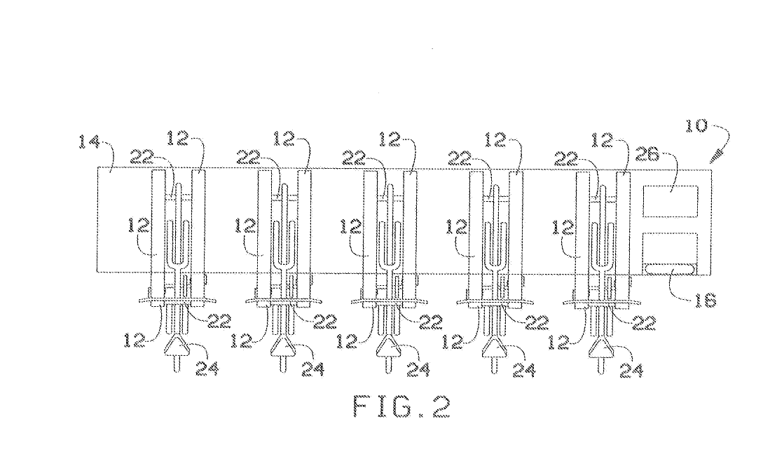

FIG. 3 depicts a front view of the embodiment of FIG. 1; and

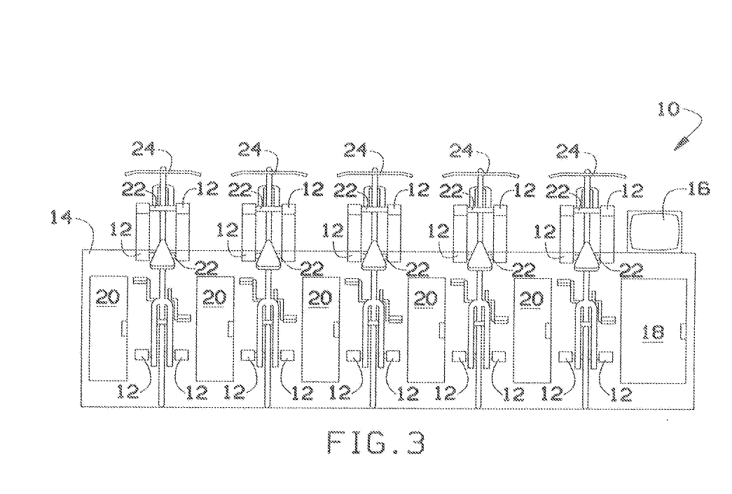

FIG. 4 depicts a side view of the embodiment of FIG. 1.

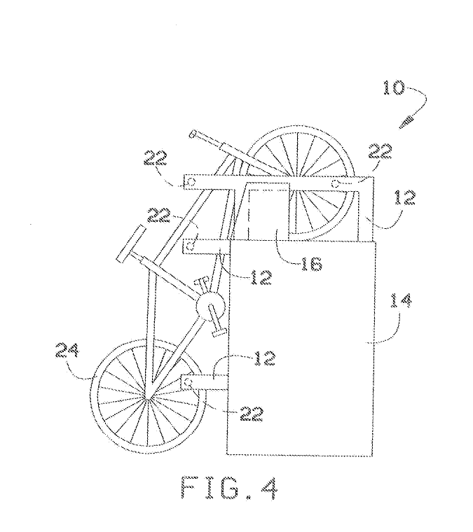

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a computerized locking system for storage of bicycles and accessories.

An embodiment of the invention is a secure storage unit for bicycles and related equipment that protects bicycles and related equipment from unauthorized removal. The unit can include a computerized access box which can control both the locking and releasing of the bicycle and equipment storage box. The rectangular storage unit can include a housing to be mounted on a support surface. The bicycles may be locked in place in distinct bicycle receiving bays located on top of the rectangular storage unit. Related equipment may be placed in distinct storage boxes housed within the storage unit. The computerized access unit can use a credit card reader and an access code receiving device that may lock a specific bay and storage box upon insertion of a bank or credit card, or by the entering of a specific access code, and may begin timing the period in which the bicycle and equipment is locked in the storage unit. When the bank or credit card is read or the access code is entered for the second time, the bicycle and the storage box may be unlocked, and the credit card may be billed for the storage charge.

As depicted in the figures, a storage unit 10 for a bicycle 24 may include metal locking braces 12, which may be attached to a base 14. A computerized access unit 16 may be accessed with an access panel. The unit also includes a storage box 20, adjustable metal locks 22, and a photovoltaic solar collector 26 for the storage box 20.

Embodiments may store helmets, gloves, backpacks, lights, and garments in the storage box. The exterior of the secure storage unit may include slots used for advertisement, and a digital computer screen.

As depicted in the embodiment of the figures, metal locking braces 12 may keep the bicycles 24 from being removed. Adjustable metal locks 22 may secure the front and rear tires and frame of the bicycles. The storage box 20 may secure equipment that is locked, and released by the computerized access unit 16, which may release the adjustable metal locks and the locking member of the storage box. The access panel 18 may provide access to the internal controls of the computerized locking unit. The photovoltaic solar collector 26 may provide the storage unit 10 with backup power stored on internal batteries. The bicycle 24 may be stored securely on the locking braces 12.

An exemplary embodiment of the present invention, as shown in the Figures, may provide secure storage for multiple bicycles 24. A bicycle 24 may be locked and released at the front tire, frame, and rear tire automatically, after receiving a code from the computerized access system. This may allow securing of bicycles. Another advantage of the bicycle storage unit may be the convenience of the internal storage boxes. The metal storage box may secure various bike equipment and accessories automatically. The locking mechanism of the storage boxes may also be locked and released automatically, after receiving a code from the computerized access system. This supports storing bike equipment and accessories. The exterior of the computerized bicycle storage unit provides slots for advertising and a digital screen. This supplies the convenience of displaying various messages for the public to view.

It should be understood, of course, that the foregoing relates to exemplary embodiments of the invention and that modifications may be made without departing from the spirit and scope of the invention as set forth in the following claims.

We claim:

1. A device for a bicycle and equipment, comprising:
a receiving bay to releasably secure the bicycle;
a storage unit to store the equipment; and
a computerized access box;
wherein the access box controls the locking and releasing of the receiving bay and the storage unit.

2. The device of claim 1, further comprising:
a plurality of receiving bays to releasably secure a plurality of bicycles;
a plurality of equipment storage units; and
a support surface for the receiving bays and the equipment storage units.

3. The device of claim 1, further comprising:
a photovoltaic solar collector to provide power to the device.

4. The device of claim 1, wherein the receiving bay secures a front tire of the bicycle, a frame of the bicycle, and a rear tire of the bicycle.

5. The device of claim 1, wherein the device is locked and released upon receiving a code from the computerized access system.

6. The device of claim 1, wherein the storage unit is adapted to store equipment including helmets, gloves, backpacks, lights, or garments.

7. The device of claim 1, wherein the computerized access unit utilizes a credit card reader adapted to read an access code upon insertion of a bank or credit card.

8. A device for a plurality of bicycles, comprising:
a plurality of receiving bays to releasably secure the bicycles;
a plurality of equipment storage units;
a support surface for the receiving bays and the equipment storage units; and
a computerized access box;
wherein the access box controls the locking and releasing of the bicycle and the storage unit.

9. The device of claim 8, wherein the device is locked and released upon receiving a code from the computerized access system.

10. The device of claim 8, wherein the computerized access unit utilizes a credit card, and reads an access code upon insertion of a bank or credit card.
